(19) United States
(12) Patent Application Publication
(10) Pub. No.: US 2011/0153276 A1
(43) Pub. Date: Jun. 23, 2011

(54) APPARATUS AND METHOD FOR PROVIDING COMPOSITE SENSOR INFORMATION

(75) Inventors: Chung-Ho LEE, Daejeon (KR); Moon-Soo LEE, Daejeon (KR); Min-Soo KIM, Daejeon (KR); In-Sung JANG, Daejeon (KR); In-Hak JOO, Daejeon (KR); Ju-Wan KIM, Daejeon (KR); Kyung-Ok KIM, Daejeon (KR); Jong-Hyun PARK, Daejeon (KR)

(73) Assignee: Electronics and Telecommunications Research Institute, Daejeon-city (KR)

(21) Appl. No.: 12/971,794

(22) Filed: Dec. 17, 2010

(30) Foreign Application Priority Data
Dec. 18, 2009 (KR) 10-2009-0127118

(51) Int. Cl. G06F 15/00

(52) U.S. Cl. 702/188

(57) ABSTRACT

Disclosed herein is an apparatus and method for providing composite sensor information. The apparatus receives sensor information from a plurality of sensors and creating a virtual sensor as a proxy for a plurality of effective sensors included in a region requested to be searched from a user terminal. Thereafter, the apparatus creates composite sensor information by fusing a plurality of the sensor information corresponding to the plurality of effective sensors included in the virtual sensor.

### CROSS REFERENCE TO RELATED APPLICATION

This application claims the benefit of Korean Patent Application No. 10-2009-0127118, filed on Dec. 18, 2009, entitled which is hereby incorporated by reference in its entirety into this application.

### BACKGROUND OF THE INVENTION

1. Technical Field

The present invention relates generally to an apparatus and method for providing sensor information which is capable of sharing sensor information over wired and/or wireless communication networks, such as a sensor web or a sensor portal. More particularly, the present invention relates to a technology which is capable of creating new composite sensor information corresponding to a user's request by combining heterogeneous types of sensor information and providing and managing the new composite sensor information. Furthermore, the present invention relates to a technology which is capable of overcoming the problem that access to sensor information is dependent on the connection or disconnection of a mobile sensor in the case of the recent provision of sensor information using mobile sensors.

2. Description of the Related Art

Recently, information sharing technology using wired and/or wireless communication networks, including the Internet, is developing rapidly. In particular, research has been actively carried out into technologies by which users acquire sensor information (or sensed information) related to information about desired regions, for example, climate information, regional information, environmental information and traffic information related to specific regions, over wired and/or wireless communication networks and use it in their daily lives.

The acquisition of such sensor information is based on a conventional structure in which communication network service providers or external information providers manage sensor information and provide the sensor information to users in a unilateral fashion. Recently, as the sharing of information among users is increasing, sensor information sharing schemes in which users share such sensor information or in which a plurality of providers exists and users use information provided by the providers are increasing. In a recently highlighted sensor information scheme, a plurality of users collects information for a specific region or a specific period of time using physical sensors possessed by the users and provides the collected information to a plurality of different users over wired and/or wireless communication networks. In particular, in such sensor information sharing schemes, there is a growing tendency to share and integrate the information provided by a plurality of mobile sensors having mobility and communication capability, such as personal Global Positioning Systems (GPSs) and cameras, which are installed in mobile devices, such as Personal Digital Assistants (PDAs) or smart phones.

Representative sensor information sharing scheme-based systems include Sensor Web Enablement (SWE) which is being established as an international standard of OGC, Microsoft's SenseWeb, Weather Underground which enables only climate sensor information, that is, the weather-related information of service sensor information, to be shared, and Yahoo's Fire Eagle which enables only location sensor information to be shared and provides location-based services.

A conventional apparatus 110 for providing sensor information based on the representative conventional sensor information sharing scheme is schematically illustrated in FIG. 1.

Referring to FIG. 1, the conventional apparatus 110 for providing sensor information includes a sensor management unit 101 for receiving sensor information from a plurality of sensors 100, managing the sensor information and providing the sensor information to a user terminal 103, and a region and user information management unit 102 for controlling the sensor management unit 101 so that it can manage information, including user information, information about the region where a user is located, and the regional information of sensor information desired by the user, and provide the sensor information desired by the user.

Using the above-described configuration, on a region (or map) basis, search and query requests are received from general users as input, and map-based sensor information is then provided. Furthermore, a web service Application Programming Interface (API) for accessing sensor information is provided to web service developers who provide the sensor information provision service, so that they can provide a variety of types of application services in conjunction with other external web services.

The conventional apparatus 110 for providing sensor information, which has the above-described configuration, integrates raw sensor data provided by sensor data providers and then provides the integrated data. Accordingly, heterogeneous sensors located in the same region are provided to a single screen regardless of different sensor providers, and a representative value, such as the average value of sensor data, is provided as integrated information. However, since the conventional technology is adapted to provide the above-described heterogeneous sensor information in an enumerative manner, it has limitations regarding the provision of fusion services providing heterogeneous sensor information. For example, a sensor installed to monitor the climate provides only climate sensor information, and a sensor installed to monitor the environment provides only environment sensor information. Accordingly, the conventional apparatus 110 has the disadvantage that, when a user desires composite sensor information in which climate sensor information and environment sensor information have been combined, a sensor provider suitable for the purpose or a web service developer newly developing and installing user-tailored service must be added thereto.

Furthermore, in the case of a mobile sensor installed in the above-described mobile device, which is one of the sources of the sensor information, connection to the apparatus for providing sensor information can be set up or released at will depending on a user's intention. Since the conventional technology is configured to directly connect to the mobile sensor of a sensor information provider, acquire sensor information and then provide the sensor information to a user, it has the problem that, when a sensor information user requests searches or queries regarding region-based sensor information, it does not easily acquire sensor information in the case where communication with a sensor information provider is cut off.

### SUMMARY OF THE INVENTION

Accordingly, an object of the present invention is to provide a technology capable of providing composite sensor information desired by a user without adding a sensor information provider including a mobile sensor or without developing a new service program.

Another object of the present invention is to provide a technology which, when a sensor information source is a mobile sensor, enables an apparatus for providing sensor information to access sensor information regardless of the communication between the mobile sensor and the apparatus for providing sensor information, thereby being able to easily provide sensor information for the region and time desired by a sensor information user.

In order to accomplish the above object, the present invention provides an apparatus for providing composite sensor information, comprising a sensor management unit for receiving sensor information from a plurality of sensors, and managing the sensor information; a region and user management unit for receiving user information and information about a region requested to be searched from a user terminal, and managing the user information and the information about a region requested to be searched; a virtual sensor creation unit for creating a virtual sensor which acts as a proxy for a plurality of effective sensors included in the region requested to be searched; and a composite sensor information processing unit for creating composite sensor information by fusing a plurality of pieces of sensor information corresponding to the plurality of effective sensors included in the virtual sensor, and transmitting the composite sensor information to the user terminal.

Additionally, in order to accomplish the above object, the present invention provides a method of providing composite sensor information, including receiving sensor information from a plurality of sensors and managing the sensor information by a sensor management unit; receiving user information and information about a region requested to be searched from a user terminal, and managing the user information and the information about a region requested to be searched by a region and user management unit; creating a virtual sensor which acts as a proxy for a plurality of effective sensors included in the region requested to be searched by a virtual sensor creation unit; creating composite sensor information by fusing a plurality of pieces of sensor information corresponding to the plurality of effective sensors included in the virtual sensor by a composite sensor information processing unit; and transmitting the composite sensor information to the user terminal by the composite sensor information processing unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a conventional apparatus for providing sensor information;

FIG. 2 is a block diagram of an apparatus for providing composite sensor information according to an embodiment of the present invention;

FIG. 3 is a diagram showing the division into lattice regions, the distribution of sensors, and the distribution of virtual sensors in the present invention;

FIG. 4 is a diagram showing the division into circular regions, the distribution of sensors, and the distribution of virtual sensors in the present invention; and

FIG. 5 is a flowchart of a method of providing composite sensor information according to an embodiment of the present invention.

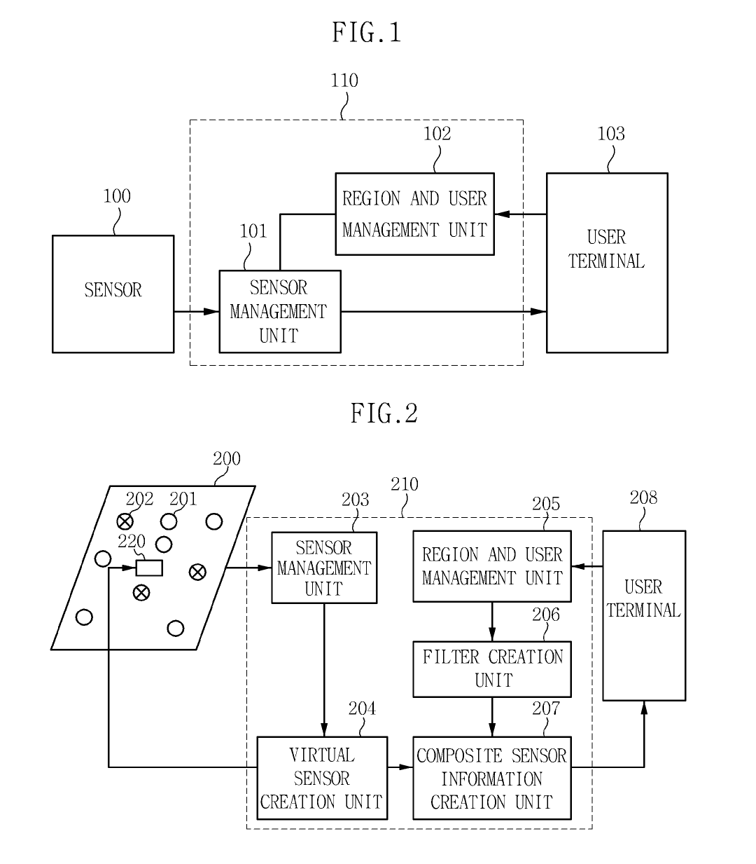

### DESCRIPTION OF THE PREFERRED EMBODIMENTS

An apparatus 210 for providing composite sensor information according to an embodiment of the present invention will now be described with reference to FIG. 2. Descriptions of the parts identical to those of the conventional technology will be omitted here.

Referring to FIG. 2, the apparatus 210 for providing composite sensor information according to the embodiment of the present invention comprises a sensor management unit 203. The sensor management unit 203 is connected to a plurality of sensors 201 and 202 of sensor information providers via wired and/or wireless communication. The sensor management unit 203 acquires a plurality of pieces of sensor information from the plurality of sensors 201 and 202. In this embodiment of the present invention, when the plurality of pieces of sensor information is acquired, each piece of sensor information may be received from each of the sensors 201 and 202 with corresponding metadata added to the piece of sensor information so as to distinguish the plurality of sensors 201 and 202 from each other. The sensor management unit 203 functions to make updates with the received sensor information or the received metadata for sensor information in real time and store and manage it, and also functions to transmit the sensor information or the metadata for sensor information to create composite sensor information.

In this embodiment of the present invention, the sensor information refers to information which can be measured by sensor information providers using the sensors 201 and 202, and the sensors 201 and 202 include all devices which are capable of acquiring surrounding information or some other information, such as cameras installed in mobile terminals. Accordingly, with regard to examples of sensor information, examples of climate information may include information such as images of the sky captured by a photographing device and the temperature and humidity acquired by physical measuring devices, and examples of environmental information may include information such as the amount of ozone, the carbon monoxide level, the amount of smoke and the quality of river water. Furthermore, in this embodiment of the present invention, the sensor information 210 may include all measurable information which is required by a user as described above. In accordance with this, it is apparent that the sensors 201 and 202 may include all measurable information which is required by a user. Furthermore, in this embodiment of the present invention, the sensor information refers to the above-described information of a predetermined region. In accordance with this, the sensors 201 and 202 are also installed in the predetermined region 200. This will be described in the following description of the region 200 in this embodiment of the present invention.

The sensor management unit 203 may perform a function to store, manage and transmit sensor information based on metadata for the sensor information. In this embodiment of the present invention, metadata for sensor information refers to any type of information which can be used to identify the sensor information. This embodiment of the present invention is configured not to directly access the physical sensors 201 and 202 and process sensor information, but to make access via a virtual sensor 220 representative of the physical sensors 201 and 202. Accordingly, although it may be possible to manage information about each of the sensors 201 and 202 as metadata, this embodiment of the present invention is configured to manage metadata for sensor information, thereby increasing the efficiency of the creation of a virtual sensor and the searching of sensor information desired by a user.

In this embodiment of the present invention, metadata for sensor information may include, for example, one or more of the time when the sensor information was measured, the target region where the sensor information was measured, and the type of sensor information. The target region where the sensor information was measured has the same concept as the above-described region 200. Furthermore, the type of sensor information is one of the types into which the above-described plurality of pieces of sensor information is classified. For example, the amount of smoke, the pollution level or the amount of ozone is classified as environmental information, and the amount of clouds, the probability of rainfall, humidity or temperature is classified as climate information. It will be apparent that in addition to the data of this embodiment of the present invention, any data may be used as metadata for sensor information as long as the data can be used to identify sensor information.

Since the sensor management unit 203 functions to transmit, receive, store and manage sensor information or metadata for sensor information as described above, it may include one or more of a communication network for carrying data, a storage unit for storing sensor information or metadata for sensor information in a database, and a processor for updating and managing sensor information or meta data for sensor information in real time.

The apparatus 210 for providing composite sensor information according to this embodiment of the present invention comprises a region and user information management unit 205. When the region and user information management unit 205 receives a request for sensor information from the user terminal 208, it receives user information or information about a region 200 where a user desires to acquire sensor information along with the request. Accordingly, the region and user information management unit 205 may further include a function of storing user information or information about a sensor information region and managing it in a real time in step with the function of receiving user information or information about a region 200 where a user desires to acquire sensor information.

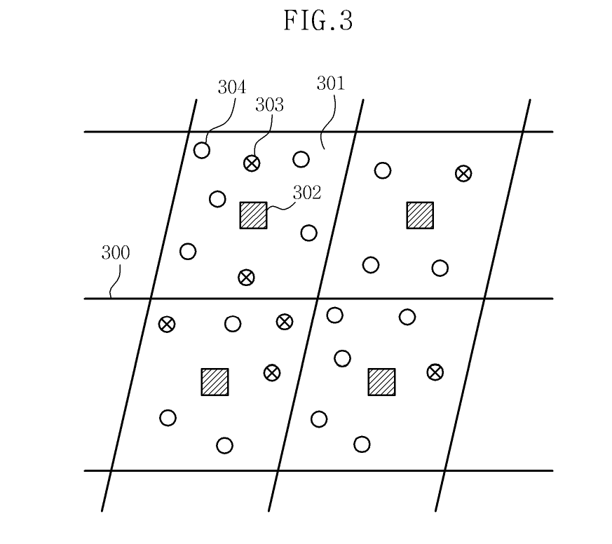

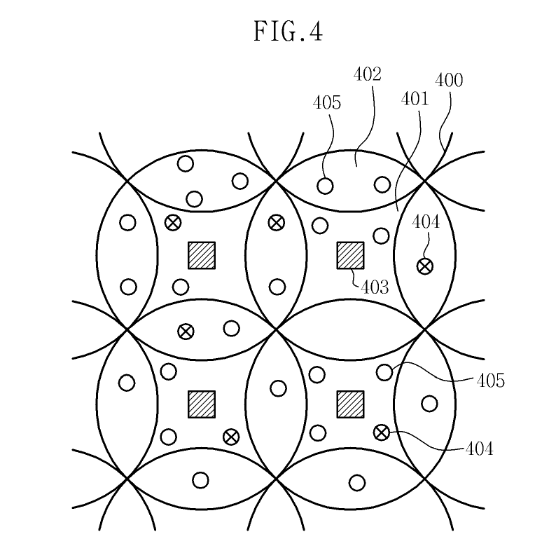

The illustration of regions according to embodiments of the present invention is given in FIGS. 3 and 4.

Referring to FIG. 3 first, a region and user information management unit 205 according to a first embodiment of the present invention manages regions in the form of lattice-shaped regions 301. The overall region is divided into lattice regions 301 having a predetermined size (for example, square lattices having a side length of 500 m), and the lattice regions 301 are managed. In this embodiment of the present invention, a region includes a concept corresponding to a space including the internal and external configurations of a predetermined place or building. Information about a region desired by a user may be determined when user information is received, and then sensor information may be collected from sensors 304 and 303 included in a lattice region 301 included in the region. The individual lattice regions 301 may be divided by region boundaries 300, as shown in FIG. 3.

Referring to FIG. 4, a region and user information management unit 205 according to a second embodiment of the present invention regarding a region divides a region into circular regions and manages them. Like in the description of the lattice regions, the region and user information management unit 205 divides the overall region into circular regions having a predetermined size (for example, circles having a diameter of 500 m), and manages them. Each of the circular regions is divided into a region 401 which does not overlap a neighboring circular region and regions 402 which overlap neighboring regions. As shown in FIG. 4, in the second embodiment of the present invention, a maximum of two circular regions overlap each other in each of the regions 402. Information about a region desired by a user may be determined when user information is received, and then sensor information may be collected from sensors 404 and 405 included in a region included in the desired region. The individual circular regions may be divided by region boundaries 400, like in FIG. 3.

The user information managed by the region and user information management unit 205 may include filtering information for sensor information required for the creation of the virtual sensor in this embodiment of the present invention, in addition to general user information, such as an ID used to identify a user, a secret number, or personal information. A user-tailored virtual sensor 220 can be created by determining condition information for the region and sensor information desired by a user based on the request for the region and sensor information desired by the user when the virtual sensor is created, rather than acquiring the sensor information of all of the sensors 201 and 202 in a region where the user desires to acquire sensor information and providing the sensor information in a unilateral fashion. In this embodiment, filtering information of the present invention may include conditions corresponding to one or more of the time when sensor information was measured, the region where sensor information was measured, the type of sensor information and content of sensor information, or may include condition information corresponding to the content of sensor information. Since conditions corresponding to one or more of the time when sensor information was measured, the region where sensor information was measured, the type of sensor information and the content of sensor information are included in metadata for sensor information as described above, filtering information in this embodiment of the present invention may be metadata for sensor information or condition information corresponding to the content of sensor information.

For example, it is assumed that a user desires composite sensor information in which environment information and climate information in a predetermined region are combined with each other. If the user desires to acquire composite sensor information into which watercourse information in a predetermined region and the probability of rainfall in the morning in the predetermined region are combined when a user requests sensor information, conditions corresponding to the time when sensor information was measured, the region where sensor information was measured, environment sensor information and climate sensor information may be set as filtering information for the above request. Furthermore, if a user desires to acquire information about the depth of the watercourse and information about the amount of rainfall when the depth of the watercourse exceeds a threshold value, the condition that the depth of the watercourse exceeds a threshold value (for example 9.5 m), which belongs to the above-described environment sensor information and is related to the details of sensor information, may be further included in filtering information. The filtering information may be input directly by a user through the user terminal 208 when the user requests sensor information, or may be set by the apparatus 210 for providing composite sensor information using the age, the gender and the like based on user information. Using the configuration, a user can be easily provided with composite sensor information into which only pieces of desired sensor information are fused, so that the present invention has the effect of providing improved user friendliness, compared with the conventional technology.

Since like the sensor management unit 203, the region and user information management unit 205 functions to receive and transmit user information or the above-described information about a region from and to the user terminal 208, to store it and to manage it in real time, the region and user information management unit 203 includes one or more of a storage unit for storing the user information or the information about a region, a processor for updating and managing user information or information about a region in real time, and wired and/or wireless communication means data for transmitting and receiving data.

The apparatus for providing composite sensor information according to this embodiment of the present invention comprises a virtual sensor creation unit 204. The virtual sensor creation unit 204 functions to create the virtual sensor 220 which acts as a proxy for a plurality of effective sensors 201 corresponding to predetermined conditions, based on user information or information about a region 200 which is received from the region and user information management unit 203, when a sensor information user requests the use of sensor information. In this embodiment of the present invention, acting as a proxy for a plurality of effective sensors 201 refers to creating the virtual sensor 220 as a proxy for the connection to the effective sensors 201 and then making the user terminal 208 access only the virtual sensor 220, without requiring the user terminals 208 to directly access the effective ones 201 of a plurality of physical sensors 201 and 202 which have effective sensor information. Accordingly, the virtual sensor 220 created by the virtual sensor creation unit 204 may vary depending on a user's request, the type of region 200, or the number or type of effective sensors 201.

In this embodiment of the present invention, the first of the predetermined conditions for creating the virtual sensor 220 as a proxy for the plurality of effective sensors 201 may be the region 200 where a user desires to acquire sensor information. Accordingly, when a plurality of effective sensors 201 included in the virtual sensor 220 is created, the virtual sensor 220 which acts as a proxy for the effective sensors 201 included in the predetermined region 200, described in conjunction with FIGS. 3 and 4, is created. Using this, when the virtual sensor 220 is created, the virtual sensor 220 may be created to act as a proxy for the effective sensors 201 located in the desired region 200 where a user desires to acquire sensor information, so that the user does not need to access the sensors 201 and 202 individually, but can access the virtual sensor 220 and acquire sensor information therefrom.

In this embodiment of the present invention, with regard to the first condition for creating the virtual sensor 220 as a proxy for the above-described plurality of sensors, the virtual sensor 220 may be created for each region 200 which was requested to be searched. From FIG. 3, it can be seen that when the virtual sensor 302 which combines a plurality of sensors 304 and 303 included in a predetermined region 301 is created, a single virtual sensor is created for each of a plurality of lattice regions. Using this, the advantage of preventing the virtual sensor 302 from being created unconditionally, the advantage of clearly defining the virtual sensor 302, and the advantage of providing highly-efficient sensor information provision services to the user terminal 208 by accessing only the virtual sensor 302 and processing sensor information regardless of the connection or disconnection of the physical sensors 303 and 304 when processing the sensor information corresponding to the virtual sensor 302 created in conformity of the first condition as described above can be achieved. As shown in FIG. 4 also, it will be apparent that virtual sensors 403 may exist in the circular regions 401 and 402, respectively.

A second condition for creating the virtual sensor 220 as a proxy for a plurality of effective sensors is related to the determination of whether sensors are effective sensors. In this embodiment of the present invention, the purpose of the determination of whether sensors are effective sensors is to overcome the problem in which in the case of a mobile sensor, the sensor and the apparatus for providing sensor information are not always connected to each other depending on a sensor information provider's intention as described above. Accordingly, using the second condition, when a virtual sensor is created, the user terminal 208 is enabled to always be provided with sensor information by determining sensors which are connected to the apparatus for providing sensor information over wired and/or wireless communications to be the effective sensors 201 so as to receive sensor information and creating the virtual sensor 220 as a proxy therefor. It will be apparent that there may be included a function of notifying the user terminal 208 of the absence of an appropriate mobile sensor if there is no mobile sensor for providing sensor information desired by a user.

Referring to FIGS. 3 and 4, in each region or the overall region, there may be connected sensors 304 and 405, while there may be disconnected sensors 303 and 404. Accordingly, each of the virtual sensors 302 and 403 combines only connected sensors 304 or 405, includes the connected sensors 304 or 405 therein, and provides composite sensor information in which sensor information corresponding to the connected sensors 304 and 405 is combined to a user. In a preferred embodiment of the present invention, the first and second conditions may be used in a combined fashion. That is, a single virtual sensor 220 is created for each region, and the virtual sensor 220 acts as a proxy only for the effective sensors 201 included in each region.

Referring to FIG. 2 again, the apparatus 210 for providing composite sensor information according to this embodiment of the present invention comprises a composite sensor information creation unit 207. The composite sensor information creation unit 207 functions to create composite sensor information into which sensor information corresponding to a plurality of effective sensors included in the virtual sensor 220 is fused as described above. At the same time, it may function to transmit created composite sensor information to the user terminal 208.

The composite sensor information creation unit 207 may further include a function of, when creating the composite sensor information, filtering the sensor information in accordance with the condition that the virtual sensor creation unit 204 creates the virtual sensor 220. Alternatively, the apparatus for providing composite sensor information may further comprise a filter creation unit 206 for filtering the plurality of pieces of sensor information to be used for the creation of composite sensor information based on the user information or the information about a region requested to be searched which was received from the region and user management unit 205 and transmitting the plurality of pieces of filtered sensor information to the composite sensor information creation unit 207.

As described above, the filter creation unit 206 filters sensor information based on user information or information about a region requested to be searched which was received from the region and user management unit 205. The conditions for the filtering may include the first and second conditions required for the creation of the virtual sensor 220. That is, whether sensor information is sensor information corresponding to a sensor included in a region requested to be searched and whether the sensor information is effective sensor information may be used as first and second conditions for the creation of composite sensor information as they are.

A third filtering condition may be related to user information. The user information which is related to a condition for the creation of composite sensor information includes filtering information which can be included in the user information as described above. The filtering information is utilized to provide user-tailored sensor information as described above. Accordingly, the third condition for the creation of composite sensor information may include one or more of conditions corresponding to, for example, the time when sensor information was measured, the region where sensor information was measured, the type of sensor information and the content of sensor information. The advantage of providing accurate sensor information desired by a user can be achieved by creating composite sensor information in conformity with the third condition and providing the composite sensor information to the user terminal 208.

The composite sensor information creation unit 207 connects a plurality of conditions included in the first to third conditions like a pipeline and then creates composite sensor information. Although the function of creating composite sensor information using the plurality of conditions included in the first to third conditions may be performed by the composite sensor information creation unit 207, the above-described filter creation unit 206 separate from the composite sensor information creation unit 207 for creating composite sensor information may be included.

For example, as described in the above description of the filtering information, when a user desires to acquire information about the depth of a watercourse and information about the amount of rainfall if the depth of the watercourse existing in a specific region exceeds a threshold value, virtual sensor information corresponding to a virtual sensor which simultaneously measures one or more of information about the watercourse, information about the average depth of the watercourse, the correlation between the depth of the watercourse and the amount of rainfall, information about the depth of the watercourse at the time when the depth of the watercourse exceeds the threshold value, and the amount of rainfall at the time when the depth of the watercourse exceeds the threshold value is created and then transmitted to the user.

Since the above-described function is performed, the user can receive and view virtual sensor information corresponding to the virtual sensor, that is, composite sensor information without receiving and viewing pieces of physical sensor information enumerated unconditionally. Accordingly, the present invention has the advantage of providing a user-friendly sensor information provision service. Furthermore, as described in the above description of the virtual sensor creation unit 204, a user can acquire desired information at the desired time (that is, regardless of the connection or disconnection of a mobile sensor), so that the present invention has the advantage of increasing the efficiency of the provision of sensor information.

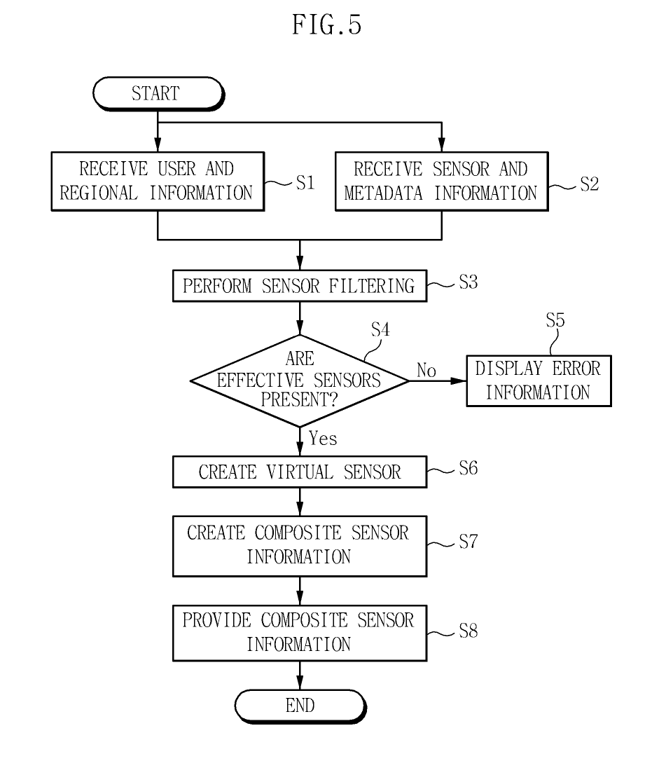

A method of providing composite sensor information using the above-described apparatus for providing composite sensor information according to an embodiment of the present invention will be described with reference to FIG. 5 below. In the following description, descriptions identical to those of the apparatus for providing composite sensor information according to this embodiment of the present invention will be omitted.

Referring to FIG. 5, in the method of providing composite sensor information according to this embodiment of the present invention comprises, the region and user management unit 205 performs step S1 of receiving user information or information about a region requested to be searched from the user terminal 208. Furthermore, the sensor management unit 203 performs step S2 of receiving sensor information or metadata for sensor information from the plurality of sensors 201 and 202, and the filter creation unit 206 performs step S3 of performing filtering to extract sensor information suitable for the above-described conditions. After step S3, step S4 of determining whether there is a plurality of pieces of effective sensor information used for the creation of composite sensor information is performed. In this embodiment of the present invention, steps S3 and S4 are the step of filtering sensor information using the filter creation unit 206 and the step of determining whether there is a plurality of effective sensors having effective sensor information using the virtual sensor creation unit 204, respectively. In FIG. 5, the step of determining whether there is a plurality of effective sensors after filtering sensor information is illustrated. However, since steps S3 and S4 are performed by the different devices as described above, they may be performed at the same time. If, as a result of the performance of step S4, there is not a plurality of effective sensors and therefore a user cannot create desired sensor information, step S5 of displaying to a user error information indicating that the creation of the sensor information failed is performed.

If there is a plurality of effective sensors, the virtual sensor creation unit 204 performs step S6 of creating a virtual sensor as a proxy for the plurality of effective sensors. Furthermore, the composite sensor information creation unit 207 performs steps S7 and S8 of creating composite sensor information into which a plurality of pieces of sensor information extracted by the filtering of step S3 is fused and then providing the composite sensor information to a user.

The apparatus and method for providing composite sensor information according to the embodiments of the present invention is advantageous in that a user can be freely provided with desired composite sensor information. Accordingly, it is not necessary to additionally register a new sensor information provider or set up a new system for providing sensor information whenever a user requests a new type of sensor information. As a result, the apparatus and method according to the present invention have the advantage of flexibly and efficiently providing sensor information. Furthermore, when sensor information is provided, the sensor information processing unit accesses a virtual sensor representative of effective actual sensors and then provides sensor information, so that the apparatus and method according to the present invention have the advantage of providing sensor information to a user regardless of the connection or disconnection of a mobile sensor, thereby providing the advantage of expanding the sensor information market using mobile sensors.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for providing composite sensor information, comprising:
a sensor management unit for receiving sensor information from a plurality of sensors, and managing the sensor information;
a region and user management unit for receiving user information and information about a region requested to be searched from a user terminal, and managing the user information and the information about a region requested to be searched;
a virtual sensor creation unit for creating a virtual sensor which acts as a proxy for a plurality of effective sensors included in the region requested to be searched; and
a composite sensor information processing unit for creating a composite sensor information by fusing a plurality of pieces of sensor information corresponding to the plurality of effective sensors included in the virtual sensor, and transmitting the composite sensor information to the user terminal.

2. The apparatus of claim 1, further comprising metadata for the sensor information;
wherein the metadata for the sensor information includes one or more of a time when the sensor information was measured, a region where the sensor information was measured, and a type of the sensor information.

3. The apparatus of in claim 1, wherein the user information includes filtering information for sensor information desired by a user.

4. The apparatus of in claim 3, wherein the filtering information is information about conditions corresponding to one or more of a time where the sensor information was measured, a region where the sensor information was measured, a type of the sensor information, and content of the sensor information.

5. The apparatus of claim 1, wherein the virtual sensor creation unit creates a single virtual sensor for the region requested to be searched.

6. The apparatus of claim 1, wherein the virtual sensor creation unit further comprises a function of determining whether each of the plurality of sensors which may be included in the virtual sensor is effective.

7. The apparatus of claim 1, wherein the composite sensor information processing unit fuses the plurality of pieces of sensor information, filtered based on the user information, when creating the composite sensor information.

8. The apparatus of claim 1, further comprising a filter creation unit for filtering the plurality of pieces of sensor information to be used for creation of the composite sensor information based on the user information or the information about a region requested to be searched, which is received from the region and user management unit, and then transmitting a plurality of pieces of filtered sensor information to the composite sensor information processing unit.

9. The apparatus of claim 1, wherein the region requested to be searched is one or more of a plurality of lattice regions which are obtained by dividing an area, corresponding to a place or a building, into polygons having a predetermined size.

10. The apparatus of claim 1, wherein the region requested to be searched is one or more of a plurality of circular regions which are obtained by dividing an area, corresponding to a place or a building, into circles having a predetermined size.

11. A method of providing composite sensor information, comprising:
receiving sensor information from a plurality of sensors and managing the sensor information by a sensor management unit;
receiving user information and information about a region requested to be searched from a user terminal, and managing the user information and the information about a region requested to be searched, by a region and user management unit;
creating a virtual sensor which acts as a proxy for a plurality of effective sensors included in the region requested to be searched by a virtual sensor creation unit;
creating a composite sensor information by fusing a plurality of pieces of the sensor information corresponding to the plurality of effective sensors included in the virtual sensor by a composite sensor information processing unit; and
transmitting the composite sensor information to the user terminal, by the composite sensor information processing unit.

12. The method of claim 11, further comprising metadata for the sensor information;
wherein the metadata for the sensor information includes one or more of a time when the sensor information was measured, a region where the sensor information was measured, and a type of the sensor information.

13. The method of claim 11, wherein the user information includes filtering information for sensor information desired by a user.

14. The method of claim 13, wherein the filtering information is information about conditions corresponding to one or more of a time where the sensor information was measured, a region where the sensor information was measured, a type of the sensor information, and content of the sensor information.

15. The method of claim 11, wherein the creating a virtual sensor comprises creating a single virtual sensor for the region requested to be searched.

16. The method of claim 11, further comprising determining whether each of the plurality of sensors which may be included in the virtual sensor is effective.

17. The method of claim 11, wherein the creating the composite sensor information comprises fusing the plurality of pieces of the sensor information, filtered based on the user information.

18. The method of claim 11, further comprising filtering the plurality of pieces of the sensor information to be used for creation of the composite sensor information based on the user information or the information about a region requested to be searched which is received from the region and user management unit; and
transmitting a plurality of filtered sensor information to the composite sensor information processing unit.

19. The method of claim 11, wherein the region requested to be searched is one or more of a plurality of lattice regions which are obtained by dividing an area, corresponding to a place or a building, into polygons having a predetermined size.

20. The method of claim 11, wherein the region requested to be searched is one or more of a plurality of circular regions which are obtained by dividing an area, corresponding to a place or a building, into circles having a predetermined size.
